(19) United States
(12) Patent Application Publication
(10) Pub. No.: US 2019/0164064 A1
(43) Pub. Date: May 30, 2019

(54) QUESTION AND ANSWER INTERACTION METHOD AND DEVICE, AND COMPUTER READABLE STORAGE MEDIUM

(71) Applicant: Shanghai Xiaoi Robot Technology Co., Ltd., Shanghai (CN)

(72) Inventors: Bo LI, Shanghai (CN); Yongmei ZENG, Shanghai (CN); Jie CHENG, Shanghai (CN); Pinpin ZHU, Shanghai (CN)

(21) Appl. No.: 16/052,143

(22) Filed: Aug. 1, 2018

(30) Foreign Application Priority Data
Nov. 27, 2017 (CN) 201711206831.4
Nov. 30, 2017 (CN) 201711245866.9
Nov. 30, 2017 (CN) 201711246023.0
Jan. 17, 2018 (CN) 201810046648.0

(51) Int. Cl. G06N 5/02; G06F 17/30

(52) U.S. Cl. CPC G06N 5/02; G06F 17/30522

(57) ABSTRACT

A question and answer interaction method includes: receiving a question from a user, the question including at least one intention and at least one element related to each of the at least one intention; performing intention analysis on the question to obtain the at least one intention and the at least one element related to each of the at least one intention; obtaining an answer corresponding to the question according to the at least one intention and the at least one element related to each of the at least one intention; and sending the answer to the user.

### CROSS-REFERENCE TO RELATED APPLICATIONS

The present application claims priority to Chinese Patent Application No. 201711206831.4 filed on Nov. 27, 2017, Chinese Patent Application No. 201711246023.0 filed on Nov. 30, 2017 and Chinese Patent Application No. 201810046648.0 filed on Jan. 17, 2018 claiming priority to Chinese Patent Application No. 201711245866.9 filed on Nov. 30, 2017, all contents of which are incorporated by reference herein.

### TECHNICAL FIELD

Embodiments of the present invention relate to the field of human-computer interaction technologies, particularly to a question and answer interaction method and device, and a computer readable storage medium.

### BACKGROUND

Human-Computer Interaction (HCI) focuses on interactive relationship between systems and users. The systems can be a wide variety of machines or computerized systems and software. For example, various artificial intelligence systems such as intelligent customer service systems and voice control systems can be realized through human-computer interaction.

An intelligent question answering system is a typical application of human-computer interaction. A traditional intelligent question answering system is to directly calculate similarity between the question raised by a user and a large number of questions stored in a repository, and get an answer that matches the question. However, since complete similarity calculation should be performed for each question with this method, the calculation amount is very large, resulting in low computational efficiency. In addition, only single-intention questions or multi-intention questions in which sentences can be effectively punctuated can be answered with this method, and the answers made have low accuracy, thus the user experience is poor.

### SUMMARY

Embodiment of the present invention are directed toward a question and answer interaction method and device, a computer device and a computer readable storage medium, which can improve the calculation efficiency and the accuracy of the answers made.

An aspect of the present invention provides a question and answer interaction method, comprising: receiving a question from a user, the question including at least one intention and at least one element related to each of the at least one intention; performing intention analysis on the question to obtain the at least one intention and the at least one element related to each of the at least one intention; obtaining an answer corresponding to the question according to the at least one intention and the at least one element related to each of the at least one intention; and sending the answer to the user.

In an embodiment, the performing intention analysis on the question to obtain the at least one intention and the at least one element related to each of the at least one intention includes: performing word segmentation processing on the question to obtain a plurality of words; and obtaining the at least one intention from a repository according to the plurality of words, each of the at least one intention corresponding to at least one word of the plurality of words, and the at least one element corresponding to words in the plurality of words other than the at least one word.

In an embodiment, the performing word segmentation processing on the question to obtain a plurality of words includes: performing word segmentation processing on the question according to a preset word segmentation rule and a preset word segmentation dictionary to obtain the plurality of words.

In an embodiment, the repository includes a plurality of preset intention knowledge points, and obtaining the at least one intention from a repository according to the plurality of words includes: respectively performing semantic parsing on the plurality of words to obtain semantic information of the plurality of words; matching the semantic information with the plurality of preset intention knowledge points to determine at least one matched intention knowledge point; and obtaining the at least one intention corresponding to the at least one matched intention knowledge point.

In an embodiment, the matching the semantic information with the plurality of preset intention knowledge points to determine at least one matched intention knowledge point includes: calculating semantic similarity between the semantic information and the plurality of preset intention knowledge points; and taking an intention knowledge point with the highest semantic similarity as the at least one matched intention knowledge point.

In an embodiment, before respectively performing semantic parsing on the plurality of words to obtain semantic information of the plurality of words, the obtaining the at least one intention from a repository according to the plurality of words further includes: performing filtering processing on the plurality of words to obtain at least one keyword, wherein the respectively performing semantic parsing on the plurality of words to obtain semantic information of the plurality of words includes: respectively performing semantic parsing on the at least one keyword to obtain semantic information of the plurality of words.

In an embodiment, the filter processing uses at least one of the following ways: removing prefixes and suffixes, and removing stop words.

In an embodiment, the semantic information includes at least one of synonyms of the plurality of words, synonyms combinations of the plurality of words, similar words of the plurality of words, similar words combinations of the plurality of words, and entities with same or similar structures as the plurality of words.

In an embodiment, the obtaining an answer corresponding to the question according to the at least one intention and the at least one element related to each of the at least one intention includes: matching the at least one element with a plurality of preset element knowledge points in a repository to determine at least one matched element knowledge point; and performing a corresponding preset branching process according to the at least one matched element knowledge point to obtain an answer corresponding to the preset branching process, an element branching process corresponding to each intention being stored in advance, the preset branching process being formed by connecting at least one group of element knowledge points corresponding to each intention knowledge point, each group of element knowledge points including at least one element knowledge point, and each element knowledge point process pointing to other group of element knowledge points or answers.

In an embodiment, the performing a corresponding preset branching process includes: determining whether elements of at least one intention of the at least one intention are sufficient to trigger an answer; and outputting a corresponding answer if elements of at least one intention of the at least one intention are sufficient to trigger an answer; and requiring the user to complete elements used to trigger an answer in a form of a rhetorical question if elements of at least one intention of the at least one intention are not sufficient to trigger an answer.

In an embodiment, the matching the at least one element with a plurality of preset element knowledge points in a repository to determine at least one matched element knowledge point includes: calculating semantic similarity between the at least one element and the plurality of preset element knowledge points, each of the at least one intention corresponding to at least one word of the plurality of words, and the at least one element corresponding to words in the plurality of words other than the at least one word; and taking an element knowledge point with the highest semantic similarity as the at least one matched element knowledge point.

In an embodiment, each of the at least one group of element knowledge points includes an affirmative element knowledge point and a negative element knowledge point of a same semantic condition.

In an embodiment, the question includes one or more of the following: a voice message, a picture message, an image message and a video message, and the question and answer interaction method further includes: converting the question into a text message.

Another aspect of the present invention provides a question and answer interaction device, comprising: a processor; a memory for storing instructions executable by the processor; wherein the processor executes the instructions to perform the following steps: receiving a question from a user, the question including at least one intention and at least one element related to each of the at least one intention; performing intention analysis on the question to obtain the at least one intention and the at least one element related to each of the at least one intention; obtaining an answer corresponding to the question according to the at least one intention and the at least one element related to each of the at least one intention; and sending the answer to the user.

In an embodiment, the performing intention analysis on the question to obtain the at least one intention and the at least one element related to each of the at least one intention includes: performing word segmentation processing on the question to obtain a plurality of words; and obtaining the at least one intention from a repository according to the plurality of words, each of the at least one intention corresponding to at least one word of the plurality of words, and the at least one element corresponding to words in the plurality of words other than the at least one word.

In an embodiment, the repository includes a plurality of preset intention knowledge points, and the obtaining the at least one intention from a repository according to the plurality of words includes: respectively performing semantic parsing on the plurality of words to obtain semantic information of the plurality of words; matching the semantic information with the plurality of preset intention knowledge points to determine at least one matched intention knowledge point; and obtaining the at least one intention corresponding to the at least one matched intention knowledge point.

In an embodiment, the obtaining the at least one intention from a repository according to the plurality of words further includes: performing filtering processing on the plurality of words to obtain at least one keyword, wherein the respectively performing semantic parsing on the plurality of words to obtain semantic information of the plurality of words includes: respectively performing semantic parsing on the at least one keyword to obtain semantic information of the plurality of words.

In an embodiment, the obtaining an answer corresponding to the question according to the at least one intention and the at least one element related to each of the at least one intention includes: matching the at least one element with a plurality of preset element knowledge points in a repository to determine at least one matched element knowledge point; and performing a corresponding preset branching process according to the at least one matched element knowledge point to obtain an answer corresponding to the preset branching process, an element branching process corresponding to each intention being stored in advance, the preset branching process being formed by connecting at least one group of element knowledge points corresponding to each intention knowledge point, each group of element knowledge points including at least one element knowledge point, and each element knowledge point process pointing to other group of element knowledge points or answers.

In an embodiment, the performing a corresponding preset branching process includes: determining whether elements of at least one intention of the at least one intention are sufficient to trigger an answer; and outputting a corresponding answer if elements of at least one intention of the at least one intention are sufficient to trigger an answer; and requiring the user to complete elements used to trigger an answer in a form of a rhetorical question if elements of at least one intention of the at least one intention are not sufficient to trigger an answer.

Still another aspect of the present invention provides a computer device, comprising: a memory, a processor and executable instructions stored in the memory and executable in the processor, wherein the processor may implement any one of question and answer interaction methods described above when executing the executable instructions.

Yet still another aspect of the present invention provides a computer readable storage medium, which is stored with computer executable instructions, any one of question and answer interaction methods described above may be implemented when the executable instructions are executed by a processor.

In the technical solutions according to the embodiments of the present invention, at least one intention and at least one element related to each of the at least one intention are obtained by receiving a question from a user and performing intention analysis on the question, an answer corresponding to the question is obtained according to the at least one intention and the at least one element related to each of the at least one intention, and the answer is sent to the user, so that the calculation efficiency and the accuracy of the answer response can be improved.

It may be understood that the foregoing general description and the following detailed description are merely illustrative and explanative, but cannot limit the present invention.

### BRIEF DESCRIPTION OF DRAWINGS

The above and other aspects of the present invention will become more apparent from the following detailed description when taken in conjunction with the accompanying drawings in which:

FIG. 1 is a flowchart illustrating a question and answer interaction method according to an exemplary embodiment of the present invention;

FIG. 2 is a flowchart illustrating a question and answer interaction method according to another exemplary embodiment of the present invention;

FIG. 3 is a flowchart illustrating a question and answer interaction method according to still another exemplary embodiment of the present invention;

FIG. 4 is a flowchart illustrating a question and answer interaction method according to yet still another exemplary embodiment of the present invention;

FIG. 5 is a flowchart illustrating a question and answer interaction method according to yet still another exemplary embodiment of the present invention;

FIG. 6 is a block diagram illustrating a question and answer interaction device according to an exemplary embodiment of the present invention;

FIG. 7 is a block diagram illustrating an analysis module in the question and answer interaction device shown in the embodiment of FIG. 6;

FIG. 8 is a block diagram illustrating an acquisition unit in the question and answer interaction device shown in the embodiment of FIG. 7;

FIG. 9 is a block diagram illustrating an acquisition module in the question and answer interaction device shown in the embodiment of FIG. 6;

FIG. 10 is a block diagram illustrating an answer acquisition unit in the question and answer interaction device shown in the embodiment of FIG. 9;

FIG. 11 is a block diagram illustrating a question and answer interaction device according to another exemplary embodiment of the present invention;

FIG. 12 is a block diagram illustrating a question and answer interaction device according to still another exemplary embodiment of the present invention; and

FIG. 13 is a block diagram illustrating a device used for question and answer interaction according to an exemplary embodiment of the present invention.

### DETAILED DESCRIPTION

In the following detailed description, embodiments will be described with reference to the accompanying drawings. However, the present invention may be embodied in various different forms, and should not be construed as being limited only to the illustrated embodiments. Rather, these embodiments are provided as examples, simply by way of illustrating the concept of the present invention to those skilled in the art. Accordingly, processes, elements, and techniques that should be apparent to those of ordinary skill in the art are not described herein.

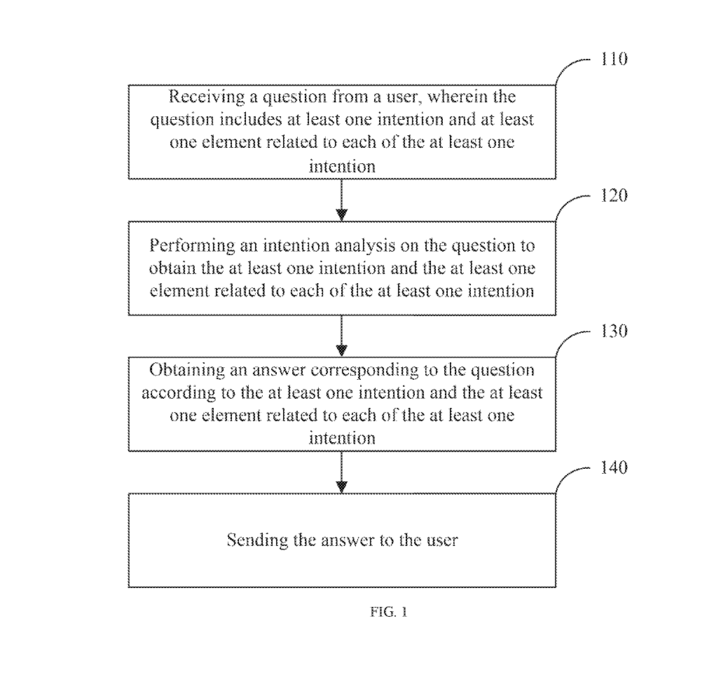

FIG. 1 is a flowchart illustrating a question and answer interaction method according to an exemplary embodiment of the present invention. The question and answer interaction method in FIG. 1 may be performed by a human-computer interaction device (for example, an intelligent question answering system, etc.). As shown in FIG. 1, the question and answer interaction method includes the following steps:

Step 110: receiving a question from a user, wherein the question includes at least one intention and at least one element related to each of the at least one intention.

In the embodiments of the present invention, the question from a user may include one or more intentions, an intention may include one or more elements, and the question may only include an element or a part of elements corresponding to an intention.

Further, the question from a user may be text information input by the user through a keyboard or a touch screen, or voice information input by the user through a microphone or the like, or may be a text message, a data link, a voice message, a picture message, an image message, a video message and the like input by the user through an interactive terminal, which is not limited by the present invention.

The interactive terminal herein is a device capable of interacting information with the intelligent question answering system, such as a smartphone, a tablet computer, a personal computer or other intelligent terminals. For example, the user can ask a question through the voice or video to the intelligent question answering system while sending a corresponding data link to the intelligent question answering system through the interactive terminal.

It should be noted that, when the received question is a voice message, a picture message, an image message or a video message, the intelligent question answering system may convert the voice message, the picture message, the image message or the video message into a text message through a voice recognition module, a picture recognition module or a video recognition module, etc.

Step 120: performing intention analysis on the question to obtain the at least one intention and the at least one element related to each of the at least one intention.

In the embodiments of the present invention, the intention is obtained by matching with intentions preset in a database through the natural language processing method. Here, the database is a repository that stores intention knowledge points. The intention analysis on the question from a user may be performed according to the result of the word segmentation processing or the sentence segmentation processing, for example, through semantic parsing, intention matching, and the like. Further, a plurality of words after the word segmentation may be arranged and combined according to the result of the word segmentation processing, and the intention analysis on the question from a user may be performed based on the result of the word combination. In addition, the question may be processed by other natural language analysis models obtained through corpus training, so as to obtain the semantic content of the question, and the intention analysis on the question from a user may be performed according to the semantic content of the question, which is not limited by the present invention.

Specifically, the word segmentation processing may adopt one or more of the bidirectional maximum matching method, the Viterbi algorithm, the Hidden Markov Model (HMM) algorithm and the Conditional Random Field (CRF) algorithm. The sentence segmentation processing is to divide the question from a user into a plurality of short sentences through separators such as commas, semicolons, periods, question marks or exclamations; or split the question from a user according to fixed words. The word combination is to arrange and combine a plurality of words together, and the intention expressed by these words after the arrangement and the combination may be one or more. The semantic content may be obtained through the overall semantic parsing of the question from a user through other natural language analysis models obtained through corpus training.

Step 130: obtaining an answer corresponding to the question according to the at least one intention and the at least one element related to each of the at least one intention.

In the embodiments of the present invention, the corresponding intention process is entered according to the at least one intention, and the corresponding element process is further executed according to the at least one element related to each of the at least one intention, thus an answer corresponding to the question is obtained.

It should be noted that the intention process and the element process are preset. Specifically, taking the intelligent question answering system of the medical consultation as an example, it is assumed that the question from a user is “I have pain in my head and cervical vertebrae, and still have a little cold, a fever of 39 degrees, what should I do?”. The intention and the elements of the question from a user may be obtained through the intention analysis, the intention is “cold, what to do”, and the elements are “both head and cervical vertebrae pain” and “fever more than 38 degrees”, then the intelligent question answering system automatically enters the intention process related to “cold” and further executes the element process related to the elements of “both head and cervical vertebrae pain” and “fever more than 38 degrees”, so as to get the relevant answer and suggestions.

Step 140: sending the answer to the user.

In the embodiments of the present invention, the answer may be sent to the user in one or more ways of text, voice, picture, image and video.

Specifically, taking the intelligent online customer service system of China Merchants Bank as an example, if the user enters “how to repay the credit card of China Merchants Bank” in text form, then the intelligent online customer service system of China Merchants Bank replies that “you can repay at the counter or ATM of China Merchants Bank, or you can repay through online banking, automatic transfer, etc.” in text form. At the same time, the user interface of the intelligent online customer service system will display the information of China Merchants Bank in the vicinity of the user's current location, and the user can click on the information to navigate to nearby China Merchants Bank for repayment.

In the technical solutions according to the embodiments of the present invention, at least one intention and at least one element related to each of the at least one intention are obtained by receiving a question from a user and performing intention analysis on the question, an answer corresponding to the question is obtained according to the at least one intention and the at least one element related to each of the at least one intention, and the answer is sent to the user, so that the calculation efficiency and the accuracy of the answer response can be improved.

In an embodiment of the present invention, performing intention analysis on the question, and obtaining the at least one intention and the at least one element related to each of the at least one intention includes: performing word segmentation processing on the question to obtain a plurality of words; and obtaining the at least one intention from a repository according to the plurality of words, wherein each of the at least one intention corresponds to at least one word of the plurality of words, and the at least one element corresponds to words in the plurality of words other than the at least one word.

Specifically, the word segmentation processing on the question from a user is performed according to a preset word segmentation rule and a preset word segmentation dictionary to obtain the plurality of words. Here, the word segmentation rule may include, but is not limited to, the forward maximum matching method, the reverse maximum matching method, the word-by-word traversal method or the word frequency statistics method, the least segmentation method, the double-phase matching method and so on.

Further, taking the received question from a user “how to activate the credit card of China Merchants Bank by telephoner?” as an example, the intelligent question answering system may perform the word segmentation processing on the question from a user “how to activate the credit card of China Merchants Bank by telephone?” by the word-by-word traversal method, and get a plurality of words “how”, “by”, “telephone”, “activate”, “China Merchants Bank” and “credit card”.

It should be noted that, the question from a user may include punctuation marks, or may not include punctuation marks, which is not limited in the present invention.

In an embodiment of the present invention, obtaining an answer corresponding to the question according to the at least one intention and the at least one element related to each of the at least one intention includes: matching the at least one element with a plurality of preset element knowledge points in a repository to determine at least one matched element knowledge point; and performing a corresponding preset branching process according to the at least one matched element knowledge point to obtain an answer corresponding to the preset branching process.

In an embodiment of the present invention, the preset branching process is formed by connecting at least one group of element knowledge points corresponding to each intention knowledge point, each group of element knowledge points includes at least one element knowledge point, and each element knowledge point process points to other group of element knowledge points or answers. That is, after matching with a certain element knowledge point, the words in the question are matched with other group of element knowledge points pointed to by the element knowledge point process; or after matching with a certain element knowledge point, the answer pointed to by the element knowledge point process is output.

Specifically, elements related to the intention in the question are matched with a plurality of element knowledge points pre-stored in the repository to determine matched element knowledge points, and a preset branching process corresponding to the matched element knowledge points is further performed based on the matched element knowledge points to obtain an answer corresponding to the branching process. Here, the preset branching process is formed by connecting at least one group of element knowledge points corresponding to each intention knowledge point. Each of the at least one group of element knowledge points may include an affirmative element knowledge point and a negative element knowledge point of a same semantic condition, respectively for performing the branching process corresponding to the affirmative element knowledge point and the branching process corresponding to the negative element knowledge point.

For example, the element knowledge points of the divorce process may include a first group of element knowledge points “whether or not willing to divorce”, a second group of element knowledge points “whether there is a property dispute”, and a third group of element knowledge points “whether there is a custody dispute”, etc. Further, the first group of element knowledge points “whether or not willing to divorce” includes an affirmative element knowledge point “the other party is willing to divorce” and a negative element knowledge point “the other party is not willing to divorce”; the second group of element knowledge points “whether there is a property dispute” includes an affirmative element knowledge point “there is a property disputes” and a negative element knowledge point “there is no property dispute”; and the third group of element knowledge points “whether there is a custody dispute” includes an affirmative element knowledge point “there is a custody dispute” and a negation elemental knowledge point “there is no custody dispute”.

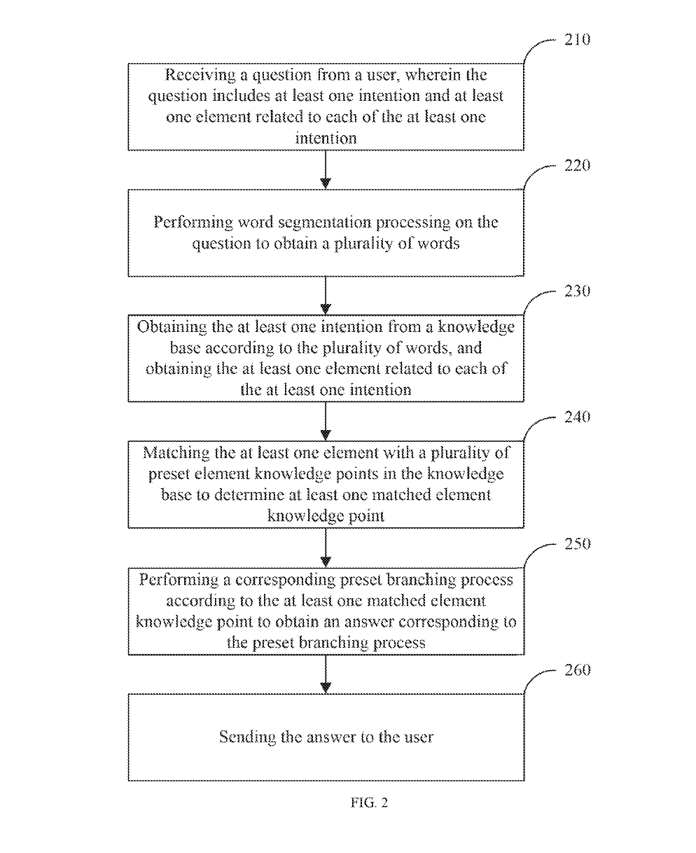

FIG. 2 is a flowchart illustrating a question and answer interaction method according to another exemplary embodiment of the present invention. As shown in FIG. 2, the question and answer interaction method includes:

Step 210: receiving a question from a user, wherein the question includes at least one intention and at least one element related to each of the at least one intention.

Step 220: performing word segmentation processing on the question to obtain a plurality of words.

In this embodiment, the word segmentation processing on the question is performed according to a preset word segmentation rule and a preset word segmentation dictionary to obtain the plurality of words.

Step 230: obtaining the at least one intention from a repository according to the plurality of words, and obtaining the at least one element related to each of the at least one intention, wherein each of the at least one intention corresponds to at least one word of the plurality of words, and the at least one element corresponds to words in the plurality of words other than the at least one word.

Step 240: matching the at least one element with a plurality of preset element knowledge points in the repository to determine at least one matched element knowledge point.

Step 250: performing a corresponding preset branching process according to the at least one matched element knowledge point to obtain an answer corresponding to the preset branching process, wherein the preset branching process is formed by connecting at least one group of element knowledge points corresponding to each intention knowledge point, each group of element knowledge points includes at least one element knowledge point, and each element knowledge point process points to other group of element knowledge points or answers.

Step 260: sending the answer to the user.

In the technical solutions according to the embodiments of the present invention, a question from a user is received, the question includes at least one intention and at least one element related to each of the at least one intention; word segmentation processing on the question is performed, and the at least one intention and the at least one element related to each of the at least one intention are obtained from the repository according to the word segmentation result; the at least one element is matched with a plurality of preset element knowledge points in the repository to determine at least one matched element knowledge point; and a corresponding preset branching process is performed according to the at least one matched element knowledge point to obtain an answer corresponding to the branching process, and the answer is sent to the user. In this way, the calculation efficiency and the accuracy of the answers made are improved.

In an embodiment of the present invention, the repository includes a plurality of preset intention knowledge points, and obtaining the at least one intention from a repository according to the plurality of words includes: respectively performing semantic parsing on the plurality of words to obtain semantic information of the plurality of words; matching the semantic information with the plurality of preset intention knowledge points to determine at least one matched intention knowledge point; and obtaining the at least one intention corresponding to the at least one matched intention knowledge point.

Specifically, before performing semantic parsing on the plurality of words, the plurality of words may be filtered to obtain at least one keyword. The filtering method may be a method of filtering the plurality of words according to the part of speech or the like, and removing prefixes and suffixes; or may be a method of filtering the plurality of words according to the frequency, and removing stop words; or may be a method of removing prefixes and suffixes first, and then removing stop words, and the like, which is not limited by the present invention. Here, removing stop words refers to removing words with little significance but high frequency of occurrence in the question, for example, “this”. “of”, “and”, etc. These words will introduce large errors in the process of calculating the similarity and can be regarded as a kind of noise. It should be noted that the filtering process can also remove some meaningless words, for example, “I”, “think”, “?”, and the like.

Then, semantic parsing is performed on the at least one keyword to obtain semantic information of the plurality of words. Generally, the semantic information refers to the information provided by any meaningful language, text, data, symbols, etc. In the embodiments of the present invention, the semantic information is an intention in the question from a user, which may be obtained by a method such as word class substitution, named entity recognition, and the like. Here, the semantic information may include, but is not limited to, synonyms and/or synonyms combinations of the words, similar words and/or similar words combinations of the words, and entities with same or similar structures as the words.

Further, semantic similarity is calculated between the semantic information and the plurality of intention knowledge points pre-stored in the repository, and an intention knowledge point with the highest semantic similarity is taken as the at least one matched intention knowledge point. Here, the semantic similarity refers to the degree of matching between the semantic information of the plurality of words and the plurality of preset intention knowledge points and element knowledge points in the repository based on words and terms, and the high similarity of semantics. The calculation of semantic similarity may be a combination of one or more methods of a calculation method based on the Vector Space Model (VSM), a calculation method based on the Latent Semantic Indexing (LSI), a semantic similarity calculation method based on the attribute theory and a semantic similarity calculation method based on Hamming distance. It should be noted that the semantic similarity calculation method may also be other calculation methods of semantic similarity.

Finally, the at least one intention corresponding to the at least one matched intention knowledge point is obtained.

In an embodiment of the present invention, matching the at least one element with a plurality of preset element knowledge points to determine at least one matched element knowledge point includes: performing semantic similarity calculation on the at least one element and the plurality of preset element knowledge points, wherein each of the at least one intention corresponds to at least one word of the plurality of words, and the at least one element corresponds to words in the plurality of words other than the at least one word; and taking an element knowledge point with the highest semantic similarity as the at least one matched element knowledge point.

Specifically, semantic similarity calculation is performed on the at least one element in the question and the plurality of element knowledge points pre-stored in the repository, and an element knowledge point with the highest semantic similarity is taken as the at least one matched element knowledge point.

In all embodiment of the present invention, a process of performing the branching process includes: determining whether elements of at least one intention of the at least one intention are sufficient to trigger an answer, if the elements of at least one intention of the at least one intention are sufficient to trigger an answer, a corresponding answer is output; or if the elements of at least one intention of the at least one intention are not sufficient to trigger an answer, the user is asked to complete elements used to trigger an answer in a form of a rhetorical question.

Specifically, whether elements related to at least one intention of the at least one intention satisfy the trigger condition of the branching process is determined, and if the trigger condition of the branching process is satisfied, the branching process is executed and an answer corresponding to the elements is output; if the trigger condition of the branching process is not satisfied, the user is prompted to complete the elements used to trigger the answer.

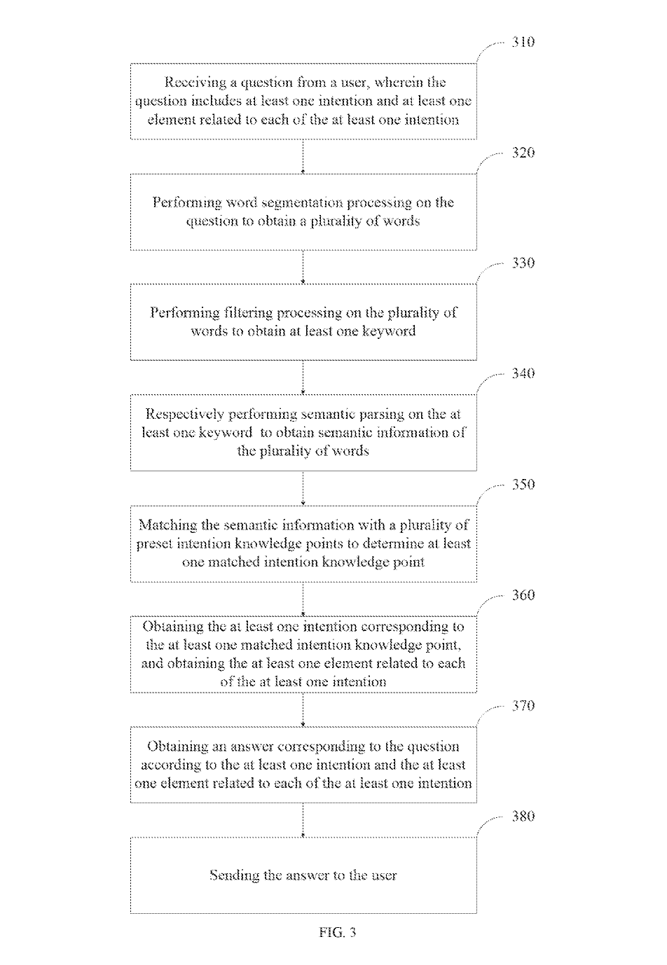

FIG. 3 is a flowchart illustrating a question and answer interaction method according to another exemplary embodiment of the present invention. As shown in FIG. 3, the question and answer interaction method includes:

Step 310: receiving a question from a user, wherein the question includes at least one intention and at least one element related to each of the at least one intention.

Step 320: performing word segmentation processing on the question to obtain a plurality of words.

Step 330: filtering the plurality of words to obtain at least one keyword.

The filtering processing adopts either or both of following ways: removing prefixes and suffixes, and removing stop words.

Step 340: respectively performing semantic parsing on the at least one keyword to obtain semantic information of the plurality of words.

Step 350: matching the semantic information with a plurality of preset intention knowledge points to determine at least one matched intention knowledge point.

Step 360: obtaining the at least one intention corresponding to the at least one matched intention knowledge point, and obtaining the at least one element related to each of the at least one intention, wherein each of the at least one intention corresponds to at least one word of the plurality of words, and the at least one element corresponds to words in the plurality of words other than the at least one word.

Step 370: obtaining an answer corresponding to the question according to the at least one intention and the at least one element related to each of the at least one intention.

Step 380: sending the answer to the user.

In the technical solutions according to the embodiments of the present invention, a question from a user is received, and the question includes at least one intention and at least one element related to each of the at least one intention. Word segmentation, and filtering prefixes, suffixes, and stop words are performed on the question to obtain keywords, semantic parsing is performed on the keywords, and at least one matched intention knowledge point is obtained. Therefore, intentions and at least one element related to each intention are obtained, that is, the at least one intention and the at least one element related to each of the at least one intention can be obtained. An answer corresponding to the question is obtained according to the at least one intention and the at least one element related to each of the at least one intention; and the answer is sent to the user. In this way, the calculation efficiency and the accuracy of the answers made are improved.

Alternative embodiments of the present invention may be formed by any combination of all above optional technical solutions, which will not be described herein.

FIG. 4 is a flowchart illustrating a question and answer interaction method according to another exemplary embodiment of the present invention. As shown in FIG. 4, the question and answer interaction method includes:

Step 410: receiving a question from a user, wherein the question includes at least one intention and at least one element related to each of the at least one intention.

In the embodiments of the present invention, the question from a user may include only one intention, or may include a plurality of intentions. In addition, the at least one element related to each of the at least one intention may be one or more, which is not limited by the present invention. For example, the question from a user is “I want to repay the credit card, where should I go? and when?”, the question contains an intention “credit card repayment” and two elements “repayment location” and “repayment time”. As another example, the question from a user is “please tell me the weather in Beijing and Shanghai today”, the question contains two intentions “weather in Beijing” and “weather in Shanghai” and one element “today”.

It should be noted that the question from a user may be one or more of a text message, a voice message, a picture message, an image message and a video message. In addition, it should be noted that the question from a user may include punctuation marks, or may not include punctuation marks.

Step 420: performing word segmentation processing on the question to obtain a plurality of words.

In the embodiments of the present invention, the word segmentation processing is performed on the question according to a preset word segmentation rule and a preset word segmentation dictionary to obtain the plurality of words. Here, the word segmentation rule may include, but is not limited to, the forward maximum matching method, the reverse maximum matching method, the word-by-word traversal method or the word frequency statistics method, the least segmentation method, the double-phase matching method and so on. The word segmentation processing may adopt one or more of the bidirectional maximum matching method, the Viterbi algorithm, the Hidden Markov Model algorithm, and the Conditional Random Field algorithm.

It should be noted that the manner in which the present invention processes the question is not limited to the word segmentation processing, but may be other suitable manner, for example, sentence segmentation, word combination and the like.

Step 430: performing semantic parsing on the plurality of words to obtain semantic information of the plurality of words.

In the embodiments of the present invention, the semantic information may include, but is not limited to, synonyms and/or synonyms combinations of the words, similar words and/or similar words combinations of the words, and entities with same or similar structures as the words.

Step 440: calculating semantic similarity between the semantic information and a plurality of preset intention knowledge points and elements knowledge points in a repository, and taking an intention knowledge point and an element knowledge point with the highest semantic similarity as a matched intention knowledge point and a matched element knowledge point respectively.

In the embodiments of the present invention, the semantic similarity refers to the degree of matching between the semantic information of a plurality of words and a plurality of preset intention knowledge points and element knowledge points in the repository based on words and terms, and the high similarity of semantics. The calculation of semantic similarity may be a combination of one or more methods of a calculation method based on the Vector Space Model, a calculation method based on the Latent Semantic Indexing, a semantic similarity calculation method based on the attribute theory and a semantic similarity calculation method based on Hamming distance. It should be noted that the semantic similarity calculation method may also be other calculation methods of semantic similarity.

Step 450: obtaining an intention corresponding to the matched intention knowledge point and an element corresponding to the matched element knowledge point.

In the embodiments of the present invention, the main process corresponding to the intention is executed based on the intention, and the branch process corresponding to the element is further executed based on the element.

Step 460: determining whether the element satisfies a trigger condition of an answer.

Step 470: if the element satisfies the trigger condition, outputting the answer corresponding to the element.

Step 480: if the element does not satisfies the trigger condition, prompting the user to complete the elements used to trigger the answer, and returning to Step 410.

Step 490: sending the answer to the user.

In the embodiments of the present invention, the answer may be presented to the user in the form of text, voice, etc.

In the technical solutions according to the embodiments of the present invention, the intention and the element related to the intention are obtained by processing the question from a user and performing semantic parsing on the question, the main process is executed based on the intention, and the corresponding branch process is executed based on the element, so that the speed and the accuracy of the answers made are improved, and the user experience is enhanced.

The question and answer interaction method above will be described in detail below by taking the divorce process of the intelligent question answering system of the legal consultation as an example.

Specifically, the intelligent question answering system receives the question from a user “I want to get a divorce, my wife is not willing, and we have a property distribution dispute, what should I do?”. The word segmentation processing including removing prefixes, suffixes and stop words is performed on the above question according to a preset word segmentation rule and a preset word segmentation dictionary, and a plurality of words “I want to divorce”, “wife is not willing”, “have a property distribution dispute”, and “how to do” are obtained.

Then, the semantic similarity between the words processed by the word segmentation processing and knowledge points (for example, “I want to divorce”, “the other party is willing to divorce”, “the other party is not willing to divorce”, “there is a property dispute”, “no property dispute”, etc.) pre-stored in the repository are calculated, and the intention “I want to divorce”, and the elements “the other party is not willing” and “there is a property dispute” of the above question are obtained.

Further, the divorce process is executed based on the intention “I want to divorce”, and the corresponding branch process is executed based on the elements “the other party is not willing” and “there is a property dispute”, legal opinions corresponding to the above question are obtained, and the legal opinions are presented to the user in text, voice and so on.

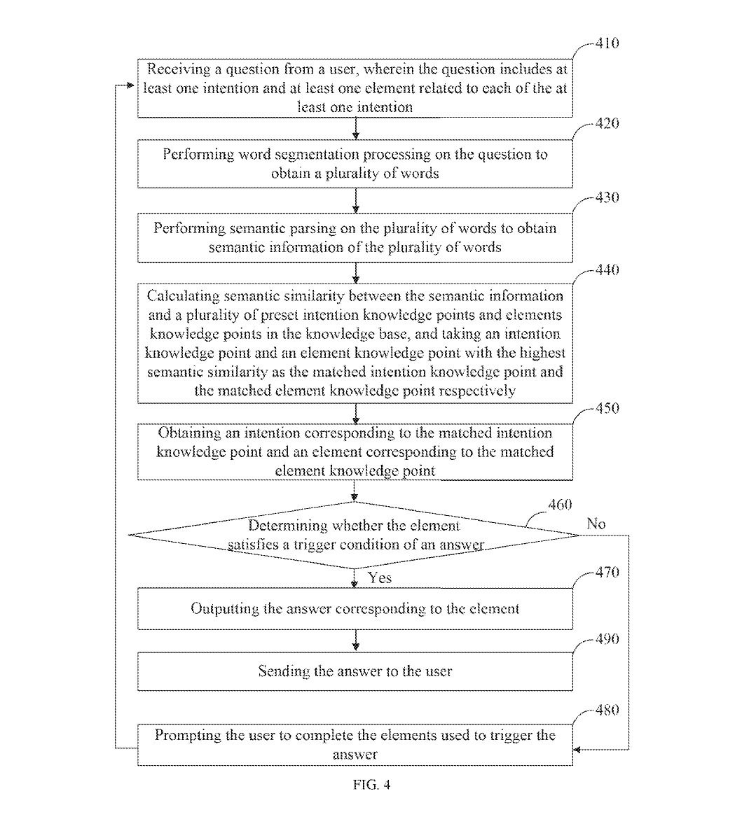

FIG. 5 is a flowchart illustrating a question and answer interaction method according to another exemplary embodiment of the present invention. As shown in FIG. 5, the question and answer interaction method includes:

Step 510: receiving a question from a user, wherein the question includes a plurality of intentions.

In embodiments of the present invention, the question from a user may include a plurality of intentions, or may include only one intention, which is not limited by the present invention. For example, the question from a user is “please tell me the weather in Beijing and Shanghai”, the question contains two intentions “weather in Beijing” and “weather in Shanghai”. As another example, the question from a user is “my credit card is lost, how should I report it?”, then the question contains only one intention, that is “credit card loss report”.

It should be noted that the question from a user may be one or more of a text message, a voice message, a picture message, an image message and a video message. In addition, it should be noted that the question from a user may include punctuation marks, or may not include punctuation marks.

Step 520: performing word segmentation processing on the question to obtain a plurality of words.

In the embodiments of the present invention, the word segmentation processing is performed on the question from a user according to a preset word segmentation rule and a preset word segmentation dictionary to obtain a word segmentation result, and the word segmentation result of the question from a user is filtered by removing prefixes, suffixes, and stop words, etc.

It should be noted that the method for processing the question is not limited to the word segmentation processing described above, but may include the sentence segmentation processing based on punctuation marks, the split processing based on semantic information or fixed words, and so on, which is not limited by the present invention.

Step 530: performing semantic parsing on the plurality of words to obtain semantic information of the plurality of words.

In the embodiments of the present invention, the semantic information may include, but is not limited to, synonyms and/or synonyms combinations of the words, similar words and/or similar words combinations of the words, and entities with same or similar structures as the words.

Step 540: combining the plurality of words according to the semantic information to obtain phrases to be matched, wherein each of the phrases to be matched includes one of the plurality of intentions.

In the embodiments of the present invention, the plurality of words are combined according to the semantic information of each of the plurality of words to obtain phrases to be matched, and each of the phrases to be matched includes at least one intention. For example, the plurality of words are “credit card”, “repayment”, “time”, “location” and “staging”, and the phrases to be matched obtained after the combination include a plurality of intentions: “credit card repayment time”, “credit card repayment location”, and “whether credit card repayment can be staging”.

Step 550: calculating semantic similarity between a combination of at least two words in the phrases to be matched and a plurality of preset extension questions in a repository according to the order in the question, and taking an intention knowledge point of an extension question with the highest semantic similarity as the user's intention.

In embodiments of the present invention, the calculation of semantic similarity may be a combination of one or more methods of a calculation method based on the Vector Space Model, a calculation method based on the Latent Semantic Indexing, a semantic similarity calculation method based on the attribute theory and a semantic similarity calculation method based on Hamming distance. For example, “credit card”, “repayment”, “time”, “location”, then the combination of at least two words in order from front to back is matched with the extension questions in the repository. The extension questions in the repository include “credit card repayment time” and “credit card repayment location”. The “credit card repayment” does not match the knowledge points in the repository, and the combination of “credit card”, “repayment”, “time” in order matches with the extension question “credit card repayment time” in the repository.

Step 560: eliminating words in the phrases to be matched of the question that have been matched to the intention, and temporarily storing the eliminated words in an eliminated word set.

In the embodiments of the present invention, after the phrases to be matched are obtained, the matched words are eliminated from the question from a user according to the consumption principle from left to right, and the eliminated words are temporarily stored in the eliminated word set.

Step 570: judging whether remaining phrases to be matched formed by remaining words in the question completely match the preset extension questions in the repository.

In the embodiments of the present invention, the remaining words in the question are arranged and combined to form the remaining phrases to be matched, and these phrases are respectively matched with the plurality of preset extension questions in the repository.

Step 580: if a combination of at least two words in the remaining phrases to be matched of the question completely matches with a preset extension question in the repository, obtaining an intention knowledge point corresponding to the matched extension question as another intention in the question.

In the embodiments of the present invention, if there is no remaining words in the question from a user, it indicates that each of the at least one extension question composed of the words in the question is completely matched with the plurality of preset extension questions, and at this time, the answer corresponding to the matched extension question is sent to the user.

It should be noted that the answer may be sent in one or more forms of text, voice, picture, image and video.

Step 590: if the remaining phrases to be matched of the question do not completely match the plurality of preset extension questions, adding missing words from the eliminated word set, and returning to Step 550.

In the embodiments of the present invention, if there are still remaining words in the remaining phrases to be matched of the question from a user, it indicates that at least one phrase to be matched, which is composed of some or all words of the remaining words to be matched in the question, is not completely matched with the preset extension questions in the repository, and the missing words are just in the eliminated word set. In this case, the missing words need to be added from the eliminated word set according to the plurality of preset extension questions, so as to completely match with the preset extension questions. Further, 550 is executed continually until all words in the question from a user are eliminated or unable to match the extension questions in the repository.

In the technical solutions according to the embodiments of the present invention, word segmentation processing, semantic parsing, arrangement and combination, and semantic information sharing are performed on the question from a user including multiple intentions, so that the speed and the accuracy of the answers made are improved, and the user experience is enhanced.

The above question and answer interaction method will be described in detail below by taking the intelligent question answering system of the hotel as an example.

Specifically, the intelligent question answering system receives the question from a user “when does the hotel breakfast start? is it a buffet? where to eat? is it free?”, obtains the result of the word segmentation by performing the word segmentation processing on the above question according to a preset word segmentation rule and a preset word segmentation dictionary, then the result of the word segmentation is filtered by removing prefixes, suffixes and stop words, and other methods, and a plurality of words “hotel”, “breakfast”, “when”, “start”, “buffet”, “where”, “eat” and “free” are obtained. Further, the above words are arranged and combined according to the semantic information of the above words to obtain multiple extension questions matched with a plurality of preset extension questions in the repository: “when does the hotel breakfast start”, “is the hotel breakfast a buffet”, “where to eat the hotel breakfast”, etc. Each of the multiple extension questions contains only one intention.

Then, the semantic similarity between the combination of at least two words in the phrases to be matched and the preset extension questions (i.e., expressions [hotel] [breakfast] [when] [start], [hotel] [breakfast] [whether] [buffet], [hotel] [breakfast] [where] [eat], [hotel] [breakfast] [whether] [free charge], etc.) in the repository are calculated according to the consumption principle from left to right, and the first matched expression [hotel] [breakfast] [when] [start] is obtained. At this time, the matched words “hotel”, “breakfast”, “when”, “start” are temporarily stored in the consumed word set, and the remaining words in the question from a user are continued to be processed.

Further, the semantic similarity calculation is performed on the remaining words “buffet”, “where”, “eat”, “free” in the question from a user and the expression in the repository. The expression stored in the repository is [hotel] [breakfast] [whether] [buffet], but the remaining words in the question from a user just contains “buffet”, therefore, two necessary words “hotel” and “breakfast” are missing. At this time, the missing two words are found from the consumed word set, and combined with the “buffet” to form a complete expression [hotel] [breakfast] [whether] [buffet], so that the expression is consumed entirely, and so on until the words in the question from a user are all consumed.

The following are embodiments of the device of the present invention, which can be used to execute embodiments of the method of the present invention. For details not disclosed in embodiments of the device of the present invention, please refer to embodiments of the method of the present invention.

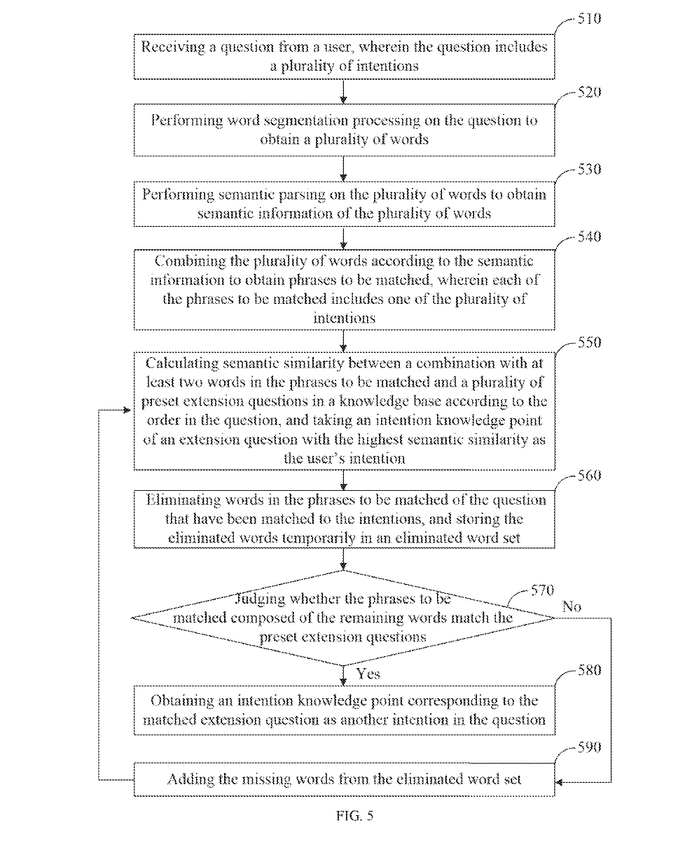

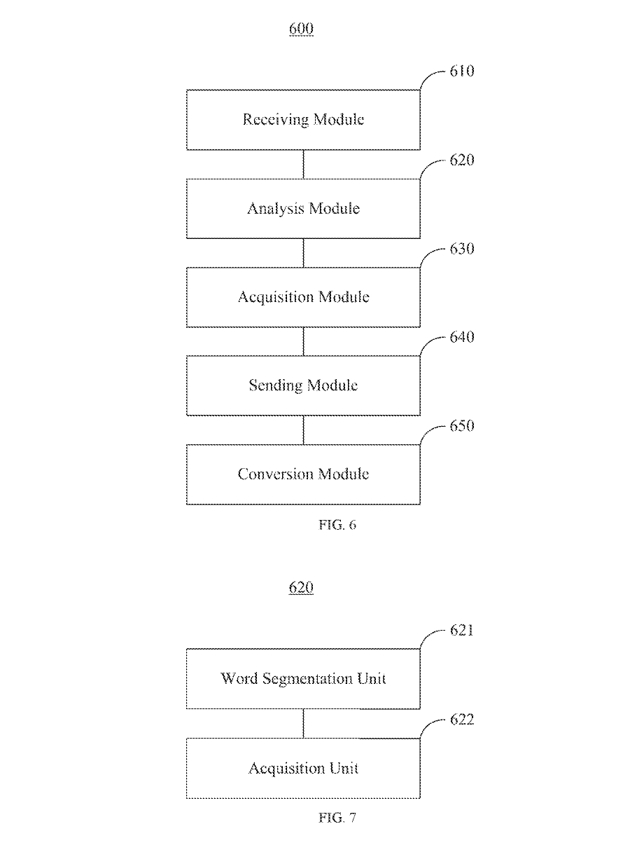

FIG. 6 is a block diagram illustrating a question and answer interaction device 600 according to an exemplary embodiment of the present invention. As shown in FIG. 6, the question and answer interaction device 600 includes:

a receiving module 610, configured to receive a question from a user, wherein the question includes at least one intention and at least one element related to each of the at least one intention;

an analysis module 620, configured to perform intention analysis on the question to obtain the at least one intention and the at least one element related to each of the at least one intention;

an acquisition module 630, configured to obtain an answer corresponding to the question according to the at least one intention and the at least one element related to each of the at least one intention; and

a sending module 640, configured to send the answer to the user.

In the technical solutions according to the embodiments of the present invention, the receiving module 610 receives a question from a user, and the question includes at least one intention and at least one element related to each of the at least one intention; the analysis module 620 performs intention analysis on the question to obtain the at least one intention and the at least one element related to each of the at least one intention; the acquisition module 630 obtains an answer corresponding to the question according to the at least one intention and the at least one element related to each of the at least one intention; and the sending module sends 640 the answer to the user. Thus, the calculation efficiency and the accuracy of the answers made can be improved.

In another embodiment of the present invention, as shown in FIG. 7, the analysis module 620 specifically includes a word segmentation unit 621 and an acquisition unit 622. The word segmentation unit 621 is configured to perform word segmentation processing on the question to obtain a plurality of words, and the acquisition unit 622 is configured to obtain the at least one intention from a repository according to the plurality of words. Each of the at least one intention corresponds to at least one word of the plurality of words, and the at least one element corresponds to words in the plurality of words other than the at least one word.

In an embodiment of the present invention, the word segmentation unit 621 may perform word segmentation processing on the question according to a preset word segmentation rule and a preset word segmentation dictionary to obtain the plurality of words.

In an embodiment of the present invention, the word segmentation rule includes any one of the forward maximum matching method, the reverse maximum matching method, the word-by-word traversal method and the word frequency statistics method.

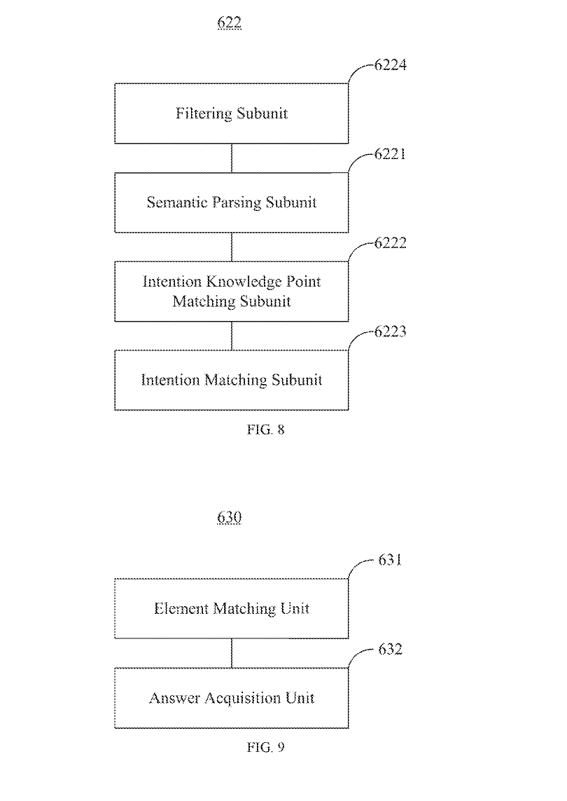

In an embodiment of the present invention, the repository includes a plurality of preset intention knowledge points. As shown in FIG. 8, the acquisition unit 622 specifically includes a semantic parsing subunit 6221, an intention knowledge point matching subunit 6222 and an intention matching subunit 6223. The semantic parsing subunit 6221 is configured to respectively perform semantic parsing on the plurality of words to obtain semantic information of the plurality of words, the intention knowledge point matching subunit 6222 is configured to match the semantic information with the plurality of preset intention knowledge points to determine at least one matched intention knowledge point, and the intention matching subunit 6223 is configured to obtain the at least one intention corresponding to the at least one matched intention knowledge point.

In another embodiment of the present invention, the intention knowledge point matching subunit 6222 is configured to calculate semantic similarity between the semantic information and the plurality of preset intention knowledge points, and take an intention knowledge point with the highest semantic similarity as the at least one matched intention knowledge point.

In another embodiment of the present invention, the semantic similarity calculation uses a combination of one or more of the following methods: a calculation method based on the Vector Space Model, a calculation method based on the Latent Semantic Indexing, a semantic similarity calculation method based on the attribute theory and a semantic similarity calculation method based on Hamming distance.

In another embodiment of the present invention, the semantic information includes at least one of synonyms and/or synonyms combinations of the plurality of words, similar words and/or similar words combinations of the plurality of words, and entities with same or similar structures as the plurality of words.

In an embodiment of the present invention, the acquisition unit 622 of FIG. 8 further includes: a filtering subunit 6224, configured to perform filtering processing on the plurality of words to obtain at least one keyword, and the semantic parsing subunit 6221 is configured to respectively perform semantic parsing on the at least one keyword to obtain semantic information of the plurality of words.

In an embodiment of the present invention, the filtering processing adopts either or both of the following ways: removing prefixes and suffixes, and removing stop words.

In an embodiment of the present invention, as shown in FIG. 9, the acquisition module 630 specifically includes an element matching unit 631 and an answer acquisition unit 632. The element matching unit 631 is configured to match the at least one element with a plurality of preset element knowledge points in a repository to determine at least one matched element knowledge point. The answer acquisition unit 632 is configured to perform a corresponding preset branching process according to the at least one matched element knowledge point to obtain an answer corresponding to the branching process. An element branching process corresponding to each intention is stored in advance, the preset branching process is formed by connecting at least one group of element knowledge points corresponding to each intention knowledge point, each group of element knowledge points includes at least one element knowledge point, and each element knowledge point process points to other group of element knowledge points or answers.

In an embodiment of the present invention, as shown in FIG. 10, the answer acquisition unit 632 specifically includes a trigger answer determining subunit 6321 and an answer decision subunit 6322. The trigger answer determining subunit 6321 is configured to determine whether elements of at least one intention of the at least one intention are sufficient to trigger an answer. The answer decision subunit 6322 is configured to output a corresponding answer if the elements of at least one intention of the at least one intention are sufficient to trigger an answer; and require the user to complete elements used to trigger an answer in a form of a rhetorical question if the elements of at least one intention of the at least one intention are not sufficient to trigger an answer.

In an embodiment of the present invention, the element matching unit 631 is configured to calculate semantic similarity between the at least one element and the plurality of preset element knowledge points. Each of the at least one intention corresponds to at least one word of the plurality of words, and the at least one element corresponds to words in the plurality of words other than the at least one word. The element matching unit 631 further takes an element knowledge point with the highest semantic similarity as the at least one matched element knowledge point.

In an embodiment of the present invention, each of the at least one group of element knowledge points includes an affirmative element knowledge point and a negative element knowledge point of a same semantic condition.

In an embodiment of the present invention, the word segmentation processing adopts one or more of the following methods: the bidirectional maximum matching method, the Viterbi algorithm, the Hidden Markov Model algorithm, and the Conditional Random Field algorithm.

In an embodiment of the present invention, the question includes one or more of the following: a text message, a voice message, a picture message, an image message and a video message.

In an embodiment of the present invention, the question is a voice message, a picture message, an image message or a video message. As shown in FIG. 6, the question and answer interaction device 600 further includes a conversion module 650 which is configured to convert the question into a text message.

The realization process of the functions and effects of the modules/units/subunits in the above device is described in detail in the realization process of corresponding steps in the above method, which is not repeated here.

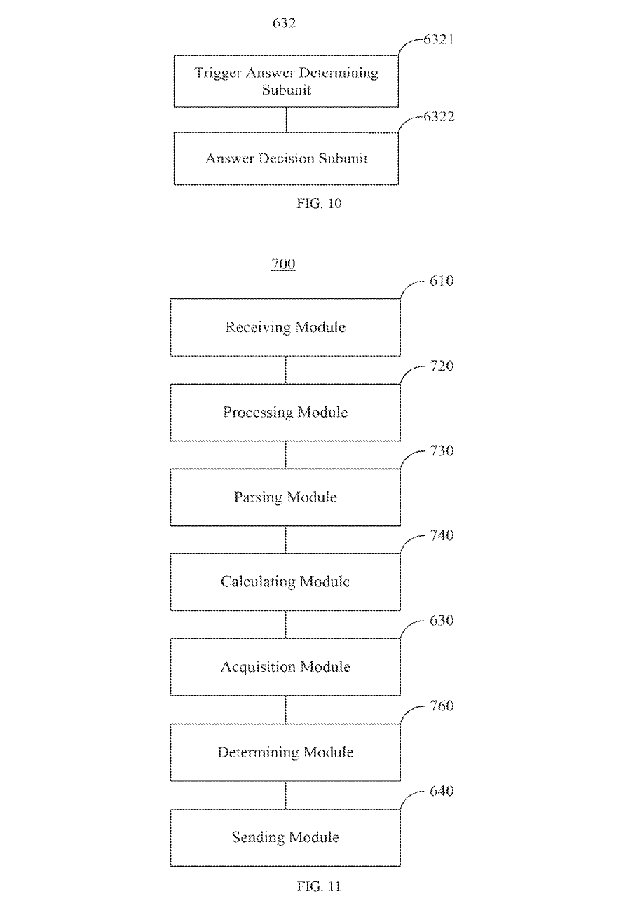

FIG, 11 is a block diagram illustrating a question and answer interaction device 700 according to another exemplary embodiment of the present invention. As shown in FIG. 11, the question and answer interaction device 700 includes:

a receiving module 610, configured to receive a question from a user, wherein the question includes at least one intention and at least one element related to each of the at least one intention;

a processing module 720, configured to perform word segmentation processing on the question to obtain a plurality of words;

a parsing module 730, configured to perform semantic parsing on the plurality of words to obtain semantic information of the plurality of words;

a calculating module 740, configured to calculate semantic similarity between the semantic information and a plurality of preset intention knowledge points and elements knowledge points in a repository, and take an intention knowledge point and an element knowledge point with the highest semantic similarity as a matched intention knowledge point and a matched element knowledge point respectively;

an acquisition module 630, configured to obtain an intention corresponding to the matched intention knowledge point and an element corresponding to the matched element knowledge point;

a determining module 760, configured to determine whether the element satisfies a trigger condition of an answer, and output the answer corresponding to the element if the element satisfies the trigger condition; and prompt the user to complete the elements used to trigger the answer and return to the receiving module 610 if the element does not satisfies the trigger condition; and

a sending module 640, configured to send the answer to the user.

In the technical solutions according to the embodiments of the present invention, the intention and the element related to the intention are obtained by processing the question from a user and performing semantic parsing on the question, the main process is executed based on the intention, and the branch process corresponding to the element is executed based on the element, so that the speed and the accuracy of the answers made are improved, and the user experience is enhanced.

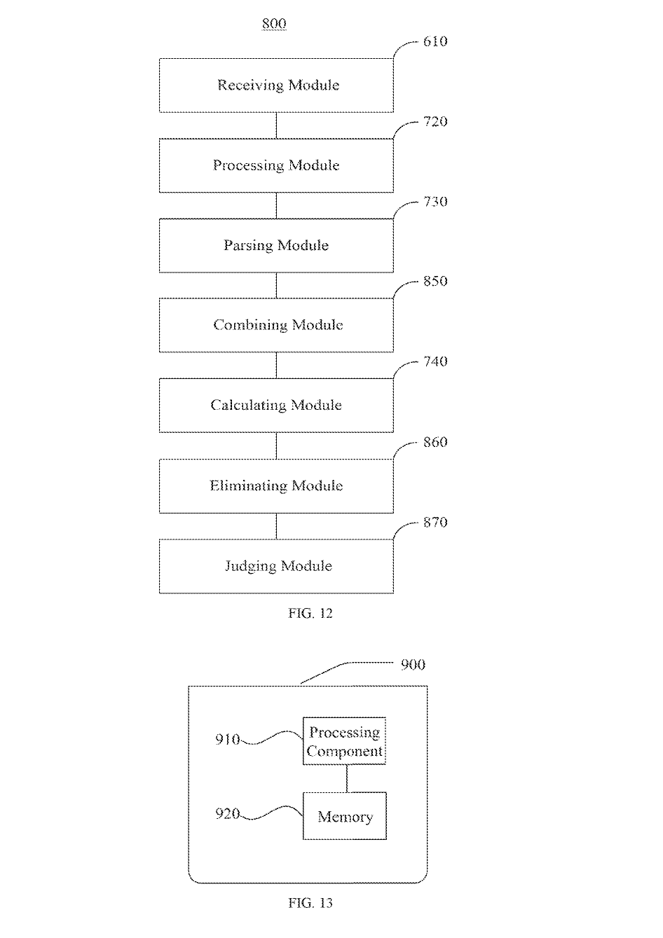

FIG. 12 is a block diagram illustrating a question and answer interaction device 800 according to another exemplary embodiment of the present invention. As shown in FIG. 12, the question and answer interaction device 800 includes:

a receiving module 610, configured to receive a question from a user, wherein the question includes a plurality of intentions;

a processing module 720, configured to perform word segmentation processing on the question to obtain a plurality of words;

a parsing module 730, configured to perform semantic parsing on the plurality of words to obtain semantic information of the plurality of words;

a combining module 850, configured to combine the plurality of words according to the semantic information to obtain phrases to be matched, wherein each of the phrases to be matched includes one of the plurality of intentions;

a calculating module 740, configured to calculate semantic similarity between a combination of at least two words in the phrases to be matched and a plurality of preset extension questions in a repository according to the order in the question, and take an intention knowledge point of an extension question with the highest semantic similarity as the user's intention;

an eliminating module 860, configured to eliminate words in the phrases to be matched of the question that have been matched to the intention, and temporarily store the eliminated words in an eliminated word set; and

a judging module 870, configured to judge whether the phrases to be matched composed of the remaining words in the question completely match the preset extension questions in the repository.

If a combination of at least two words in the remaining phrases to be matched of the question completely matches with a preset extension question in the repository, judging module 870 obtains an intention knowledge point corresponding to the matched extension question, and takes the intention knowledge point as another intention in the question. The repository includes a plurality of intention knowledge points, and each intention knowledge point includes a plurality of extension questions. If the remaining phrases to be matched of the question do not completely match the plurality of preset extension questions, and missing words are just in the eliminated word set, the judging module 870 adds the missing words from the eliminated word set to make the match complete, and returns to the calculating module 740 until all words in the question from a user are all eliminated or unable to match the extension questions in the repository.

In the technical solutions according to the embodiments of the present invention, word segmentation processing, semantic parsing, arrangement and combination, and semantic information sharing are performed on the question from a user including multiple intentions, so that the speed and the accuracy of the answers made are improved, and thus the user experience is enhanced.

FIG. 13 is a block diagram illustrating a device 900 used for question and answer interaction according to an exemplary embodiment of the present invention.

Referring to FIG. 13, the device 900 includes a processing component 910, and further includes one or more processors, and a memory resource represented by a memory 920 for storing instructions executable by the processing component 910, such as application programs. The application programs stored in the memory 920 may include one or more modules, and each module corresponds to one set of instructions. In addition, the processing component 910 is configured to execute instructions to perform the question and answer interaction method described above.

The device 900 may further include: one power supply module, configured to perform power supply management of the device 900; one wired or wireless network interface, configured to connect the device 900 to a network; and one input/output (I/O) interface. The device 900 may operate based an operating system stored in the memory 920, for example, Windows Server™, Mac OS X™, Unix™, Linux™, FreeBSD™ or the like.

A non-transitory computer readable storage medium that enables the above device 900 to perform a question and answer interaction method when the instructions in the storage medium are executed by the processor of the device 900 is also provided. The method includes: receiving a question from a user, wherein the question includes at least one intention and at least one element related to each of the at least one intention; perforating intention analysis on the question to obtain the at least one intention and the at least one element related to each of the at least one intention; obtaining an answer corresponding to the question according to the at least one intention and the at least one element related to each of the at least one intention; and sending the answer to the user.

Those skilled in the art may understand that, units and algorithm steps of the various examples described in the embodiments disclosed herein can be implemented by electronic hardware, or a combination of computer software and electronic hardware. Whether these functions are executed by hardware or software depends on the specific applications and design constraints of the technical solutions. Those skilled in the art may use different methods to implement the described functions for every specific application, but such implementation should not be considered to be beyond the scope of the present invention.

Those skilled in the art may clearly understand that, for the convenience and brevity of description, the specific working process of the system, device and unit described above can refer to the corresponding process in the foregoing method embodiments, and the details are not described here again.

It can be understood that the system, device, and method disclosed in the embodiments of the present application may be implemented in other manners. For example, the device embodiments described above are merely exemplary. For example, the module/unit division is merely a logical function division and may adopt other division manner in actual implementation. For example, multiple units or subunits may be combined or integrated into another system, or some features may be ignored or not performed. In addition, the coupling, direct coupling or communication connection shown or discussed may be an indirect coupling or communication connection through some interfaces, devices or units, and may be electrical, mechanical or other.

The units described as separate components may or may not be physically separate, and components displayed as units may or may not be physical units, may be located in one position, or may be distributed on multiple network units. Some or all of the units may be selected according to the actual needs to achieve the objectives of the solutions of the embodiments.

In addition, each functional unit in each embodiment of the present invention may be integrated into a processing unit, or each unit may exist physically separately, or two or more units are integrated into a unit.

The functions may be stored in a computer readable storage medium if implemented in the form of a software functional unit and sold or used as a separate product. Based on such understanding, the essential part or the part contributing to the prior art of technical solutions of the present invention may be embodied in the form of a software product. The computer software product may be stored in a storage medium, and includes several instructions to enable a computer device (which may be a personal computer, a server, or a network device) to execute the methods described in the embodiments of the present invention or some parts of the embodiments. The foregoing storage medium includes any medium that may store program code, such as a U-disk, a removable hard disk, a read-only memory (ROM), a random access memory (RAM), a magnetic disk or an optical disk.

The above descriptions are merely preferred specific embodiments of the present invention, and the protection scope of the present invention is not limited thereto. Variations or alternatives that may be easily derived by those skilled in the art within the technical scope disclosed by the present invention should fall in the protection scope of the present invention. Therefore, the protection scope of the present invention shall be based on the protection scope of the claims.

What is claimed is:

1. A question and answer interaction method, comprising:
receiving a question from a user, the question including at least one intention and at least one element related to each of the at least one intention;
performing intention analysis on the question to obtain the at least one intention and the at least one element related to each of the at least one intention;
obtaining an answer corresponding to the question according to the at least one intention and the at least one element related to each of the at least one intention; and
sending the answer to the user.

2. The question and answer interaction method according to claim 1, wherein the performing intention analysis on the question to obtain the at least one intention and the at least one element related to each of the at least one intention includes:
performing word segmentation processing on the question to obtain a plurality of words; and
obtaining the at least one intention from a repository according to the plurality of words, each of the at least one intention corresponding to at least one word of the plurality of words, and the at least one element corresponding to words in the plurality of words other than the at least one word.

3. The question and answer interaction method according to claim 2, wherein the performing word segmentation processing on the question to obtain a plurality of words includes:
performing word segmentation processing on the question according to a preset word segmentation rule and a preset word segmentation dictionary to obtain the plurality of words.

4. The question and answer interaction method according to claim 2, wherein the repository includes a plurality of preset intention knowledge points, and obtaining the at least one intention from a repository according to the plurality of words includes:
respectively performing semantic parsing on the plurality of words to obtain semantic information of the plurality of words;
matching the semantic information with the plurality of preset intention knowledge points to determine at least one matched intention knowledge point; and
obtaining the at least one intention corresponding to the at least one matched intention knowledge point.

5. The question and answer interaction method according to claim 4, wherein the matching the semantic information with the plurality of preset intention knowledge points to determine at least one matched intention knowledge point includes:
calculating semantic similarity between the semantic information and the plurality of preset intention knowledge points; and
taking an intention knowledge point with the highest semantic similarity as the at least one matched intention knowledge point.

6. The question and answer interaction method according to claim 4, wherein before respectively performing semantic parsing on the plurality of words to obtain semantic information of the plurality of words, the obtaining the at least one intention from a repository according to the plurality of words further includes:
performing filtering processing on the plurality of words to obtain at least one keyword,
wherein the respectively performing semantic parsing on the plurality of words to obtain semantic information of the plurality of words includes:
respectively performing semantic parsing on the at least one keyword to obtain semantic information of the plurality of words,

7. The question and answer interaction method according to claim 6, wherein the filter processing uses at least one of the following ways: removing prefixes and suffixes, and removing stop words.

8. The question and answer interaction method according to claim 4, wherein the semantic information includes at least one of synonyms of the plurality of words, synonyms combinations of the plurality of words, similar words of the plurality of words, similar words combinations of the plurality of words, and entities with same or similar structures as the plurality of words.

9. The question and answer interaction method according to claim 1, wherein the obtaining an answer corresponding to the question according to the at least one intention and the at least one element related to each of the at least one intention includes:
matching the at least one element with a plurality of preset element knowledge points in a repository to determine at least one matched element knowledge point; and
performing a corresponding preset branching process according to the at least one matched element knowledge point to obtain an answer corresponding to the preset branching process, an element branching process corresponding to each intention being stored in advance, the preset branching process being formed by connecting at least one group of element knowledge points corresponding to each intention knowledge point, each group of element knowledge points including at least one element knowledge point, and each element knowledge point process pointing to other group of element knowledge points or answers.

10. The question and answer interaction method according to claim 9, wherein the performing a corresponding preset branching process includes:
determining whether elements of at least one intention of the at least one intention are sufficient to trigger an answer; and
outputting a corresponding answer if elements of at least one intention of the at least one intention are sufficient to trigger an answer; and requiring the user to complete elements used to trigger an answer in a form of a rhetorical question if elements of at least one intention of the at least one intention are not sufficient to trigger an answer.

11. The question and answer interaction method according to claim 9, wherein the matching the at least one element with a plurality of preset element knowledge points in a repository to determine at least one matched element knowledge point includes:
calculating semantic similarity between the at least one element and the plurality of preset element knowledge points, each of the at least one intention corresponding to at least one word of the plurality of words, and the at least one element corresponding to words in the plurality of words other than the at least one word; and
taking an element knowledge point with the highest semantic similarity as the at least one matched element knowledge point.

12. The question and answer interaction method according to claim 9, wherein each of the at least one group of element knowledge points includes an affirmative element knowledge point and a negative element knowledge point of a same semantic condition.

13. The question and answer interaction method according to claim 1, wherein the question includes one or more of the following: a voice message, a picture message, an image message and a video message, and the question and answer interaction method further includes:
converting the question into a text message.

14. A question and answer interaction device, comprising:
a processor;
a memory for storing instructions executable by the processor;
wherein the processor executes the instructions to perform the following steps:
receiving a question from a user, the question including at least one intention and at least one element related to each of the at least one intention;
performing intention analysis on the question to obtain the at least one intention and the at least one element related to each of the at least one intention;
obtaining an answer corresponding to the question according to the at least one intention and the at least one element related to each of the at least one intention; and
sending the answer to the user.

15. The question and answer interaction device according to claim 14, wherein the performing intention analysis on the question to obtain the at least one intention and the at least one element related to each of the at least one intention includes:
performing word segmentation processing on the question to obtain a plurality of words; and
obtaining the at least one intention from a repository according to the plurality of words, each of the at least one intention corresponding to at least one word of the plurality of words, and the at least one element corresponding to words in the plurality of words other than the at least one word.

16. The question and answer interaction device according to claim 15, wherein the repository includes a plurality of preset intention knowledge points, and the obtaining the at least one intention from a repository according to the plurality of words includes:
respectively performing semantic parsing on the plurality of words to obtain semantic information of the plurality of words;
matching the semantic information with the plurality of preset intention knowledge points to determine at least one matched intention knowledge point; and
obtaining the at least one intention corresponding to the at least one matched intention knowledge point.

17. The question and answer interaction device according to claim 16, wherein the obtaining the at least one intention from a repository according to the plurality of words further includes:
performing filtering processing on the plurality of words to obtain at least one keyword,
wherein the respectively performing semantic parsing on the plurality of words to obtain semantic information of the plurality of words includes: respectively performing semantic parsing on the at least one keyword to obtain semantic information of the plurality of words.

18. The question and answer interaction device according to claim 14, wherein the obtaining an answer corresponding to the question according to the at least one intention and the at least one element related to each of the at least one intention includes:
matching the at least one element with a plurality of preset element knowledge points in a repository to determine at least one matched element knowledge point; and
performing a corresponding preset branching process according to the at least one matched element knowledge point to obtain an answer corresponding to the preset branching process, an element branching process corresponding to each intention being stored in advance, the preset branching process being formed by connecting at least one group of element knowledge points corresponding to each intention knowledge point, each group of element knowledge points including at least one element knowledge point, and each element knowledge point process pointing to other group of element knowledge points or answers.

19. The question and answer interaction device according to claim 18, wherein the performing a corresponding preset branching process includes:
determining whether elements of at least one intention of the at least one intention are sufficient to trigger an answer; and
outputting a corresponding answer if elements of at least one intention of the at least one intention are sufficient to trigger an answer; and requiring the user to complete elements used to trigger an answer in a form of a rhetorical question if elements of at least one intention of the at least one intention are not sufficient to trigger an answer.

20. A computer readable storage medium comprising instructions, wherein the instructions are executed by a processor in a device to implement the following steps:
receiving a question from a user, the question including at least one intention and at least one element related to each of the at least one intention;
performing intention analysis on the question to obtain the at least one intention and the at least one element related to each of the at least one intention;
obtaining an answer corresponding to the question according to the at least one intention and the at least one element related to each of the at least one intention; and
sending the answer to the user.
